(19) United States
(12) Patent Application Publication
(10) Pub. No.: US 2021/0159756 A1
(43) Pub. Date: May 27, 2021

(54) MOTOR STRUCTURE

(71) Applicant: TRICORE CORPORATION, Taichung City (TW)

(72) Inventors: CHIA-WEI LIN, TAICHUNG CITY (TW); TSUNG-YU HUNG, TAICHUNG CITY (TW)

(21) Appl. No.: 16/856,412

(22) Filed: Apr. 23, 2020

(30) Foreign Application Priority Data
Nov. 22, 2019 (TW) 108142488

(51) Int. Cl. H02K 5/15

(52) U.S. Cl. CPC H02K 5/15

(57) ABSTRACT

A motor comprises a housing having a space, a stator including a spool casing arrayed in the space, a rotor containing an axle and a magnet located inside the spool casing, the axle penetrating the magnet and having two ends protruding out of the housing, wherein the axle has two ends respectively allocated with an end-shield bearing integrating with the spool casing and an bottom-plate bearing detachably mounting on the bottom side of the housing in order to improve the concentricity of the motor.

### BACKGROUND OF THE INVENTION

### 1. Field of the Invention

The present disclosure provides a motor; especially to its structure capable of improving the concentricity of the motor.

### 2. Description of the Related Art

The conventional motor structure is mainly composed of a housing, a rotor and a stator, wherein the rotor is located relying on the end-shield bearing and the bottom-plate bearing mounted on two openings of the housing, and serves as an anchor for positioning reference which is liable to have a eccentricity problem in assembly resulting in the motor's malfunction and rumble noise in operation.

### SUMMARY OF THE INVENTION

Viewing of above-mentioned faults, this invention provides a motor structure for surely improving the rotor's concentricity after assembly.

Based on aforementioned goal, this invention offers a motor structure comprising a housing, a stator and a rotor. The housing is collaboratively assembled by an upper shell and a lower shell forming a space, the stator having a spool casing arrayed in the space and the rotor including an axle and a magnet. The magnet is located inside of the spool casing and penetrated by the axle protruding out from two ends of the housing. The axle has its two ends respectively connected to an end-shield bearing and a bottom-plate bearing, the end-shield bearing forming a unity with the spool casing and the bottom-plate bearing detachably mounting on the bottom side of the housing.

The spool casing is equipped with a pair of fixed ribs for confining the upper shell and the lower shell, both of which respectively having a number of fixed claws at an interval arrangement and the inner wall of the spool casing having a number of fixed grooves to be engaged by the claws.

Preferably, the stator further has a stator core deployed inside of the spool casing having a number of polar claws extending to the outside of the stator core.

Still preferably, the upper shell and the lower shell have openings respectively mounted with an end shield and a bottom plate.

### BRIEF DESCRIPTION OF THE DRAWINGS

FIG. 1 illustrates a perspective view of the motor structure.

FIG. 2 illustrates an explosive view of the motor structure.

FIG. 3 illustrates another perspective view of the spool casing.

FIG. 4 illustrates a cross-sectional view of the motor structure.

### DETAILED DESCRIPTION OF PREFERRED EMBODIMENTS

For delivering an articulate narration of the embodiment, the structure and the performance regarding this invention, the drawings will be referred for a better understanding.

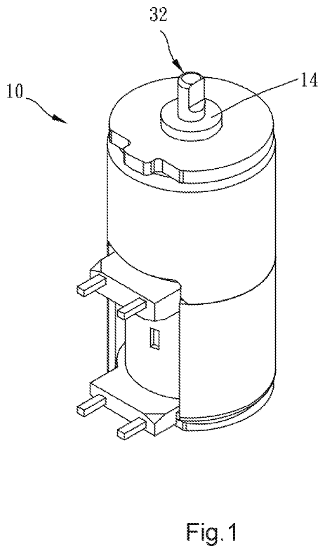

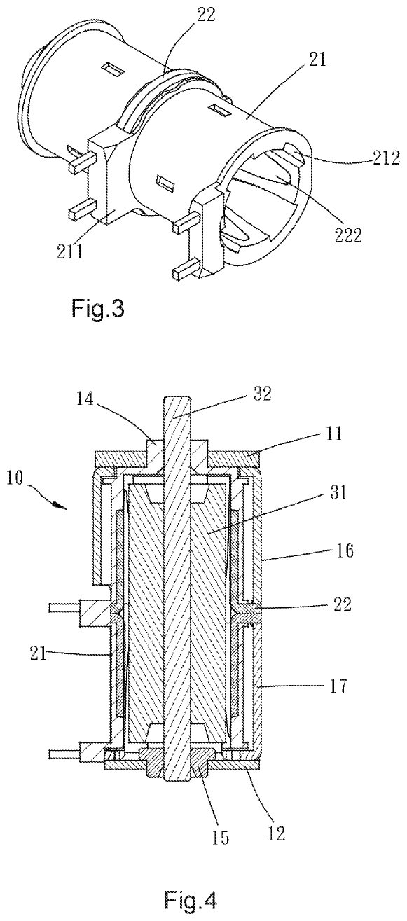

FIG. 1 to FIG. 4 illustrate a motor 100 comprising a housing, a stator and a rotor, wherein the housing forms a hollow space collaboratively assembled by an upper shell 16 and a lower shell 17 and both of which are respectively mounted on an end shield 11 and a bottom plate 12.

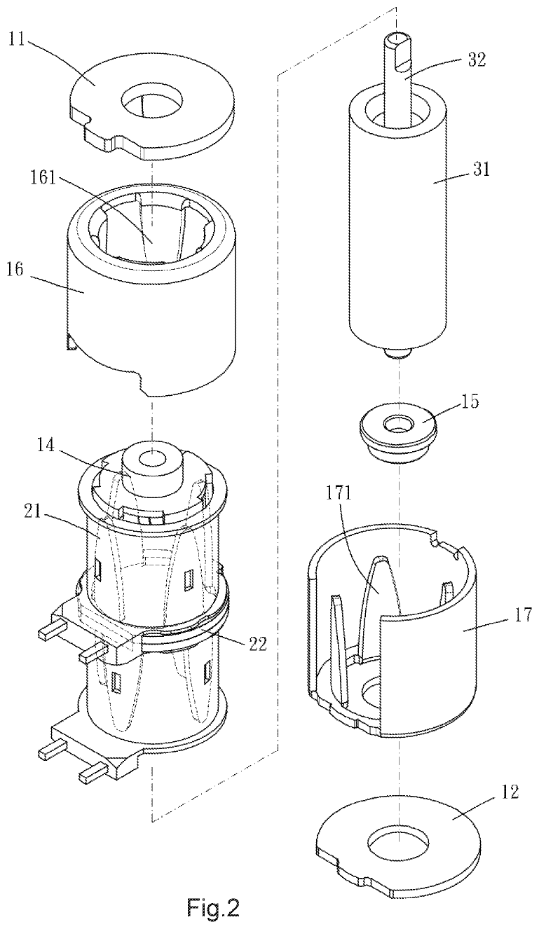

The stator is disposed in the space, as shown in FIG. 2, having a tubular spool casing 21 and a stator core 22 deployed inside the spool casing 21, wherein the stator core 22 has a number of polar claws 222 extending to the outside of the stator core 22.

The rotor includes an axle 32 and a magnet 31, the magnet 31 locating inside the spool casing 21, the axle 32 penetrating the magnet 31 with its two ends protruding out of the housing, wherein the axle 32 of the rotor has two ends connected to an end-shield bearing 14 and a bottom-plate bearing 15.

In this embodiment, the end-shield bearing 14 and the spool casing 21 form a unity made from plastic, and the bottom-shield bearing 15 is mounted on the center of the bottom plate 12. By doing so, the end-shield bearing 14 serves as an anchor for positioning reference in assembling the motor 100 in order to reduce the displacement of the axle 32 and improve the concentricity of the motor 100.

In this embodiment, the polar claws 222 have number of eight divided into two groups and arrayed isometrically, the spool casing 21 has an inner wall mounted on a plurality of fixed grooves 212 arranged between the adjacent polar claws 222.

In this embodiment, the spool casing 21 is arranged with a pair of fixed ribs 211 simultaneously engaged to the upper shell 16 and the lower shell 17 of the spool casing 21 in assembly. Wherein, the upper shell 16 and the lower shell 17 respectively have a number of fixed claws 161, 171 arranged at interval for pairing with the fixed gloves 212 for assembling the housing and the stator.

The assembling procedure of the motor 100 begins with disposing the rotor into the spool casing 21, and the axle 32 uses its one end to penetrate the end-shield bearing 14 serving as an anchor for positioning reference and the bottom-plate bearing 15 sets on the other end of the axle 32 followed by the upper and the lower shell's launching to complete an installation with simplicity and fast effect.

In this embodiment, the bottom-plate bearing 15 is a detachable devise; in the other embodiments, the bottom-plate bearing 15 and the spool casing form a unity.

1. A motor structure comprises a housing having a space, a stator having a spool casing arrayed in the space and a rotor deployed in the spool casing, the rotor having an axle with two ends connected to an end-shield bearing and a bottom-plate shield, which characteristic lies in the end-shield bearing and the spool casing forms a unity.

2. The motor structure of claim 1, wherein the housing is collaboratively assembled with an upper shell and a lower shell and both of which have a number of fixed claws arranged in partition.

3. The motor structure of claim 2, wherein the upper shell and the lower shell have their openings deployed with an end shield and a bottom plate.

4. The motor structure of claim 2, wherein the spool casing has an inner wall with a plurality of fixed grooves engaged with the fixed claws.

5. The motor structure of claim 2, wherein the spool casing is equipped with a pair of fixed ribs for confining the upper shell and the lower shell.

6. The motor structure of claim 1, wherein the stator includes a stator core deployed inside the spool casing and equipped with a number of polar claws extending to the outside of the stator core.

7. The motor structure of claim 1, wherein the rotor consists of a magnet penetrated by an axle, and the axle has two ends protruding out of the housing.

8. The motor structure of claim 1, wherein the bottom-plate bearing is detachably mounted on the bottom side of the housing.
